(19) United States
(12) Patent Application Publication
(10) Pub. No.: US 2002/0150727 A1
(43) Pub. Date: Oct. 17, 2002

(54) ORNAMENTAL WATER BALL

(76) Inventor: Yu-Shu Lin, Taoyuan (TW)

Correspondence Address: DOUGHERTY & TROXELL, SUITE 1404, 5205 LEESBURG PIKE, FALLS CHURCH, VA, 22041, US

(21) Appl. No.: 09/832,041

(22) Filed: Apr. 11, 2001

(51) Int. Cl. A01N 1/00

(52) U.S. Cl. 428/150

(57) ABSTRACT

An ornamental water ball includes a base and a soft shell portion located on a top of the base. The soft shell portion may be designed into different shapes. Two discs are separately positioned at inner and outer sides of a peripheral area surrounding a bottom opening of the soft shell portion and are locked into one unit with screws to tightly clamp the peripheral area of the soft shell portion between them. The two discs are provided at the sides facing each other with annular ribs and annular grooves that engage with one another to continuously bend the peripheral area of the soft shell portion while clamping the same between them. Inner and outer injection ports are provided at centers of the two discs and a plug is compressed between the two discs to seal the two injection ports. Ornamental liquid may be injected into the soft shell portion via the injection ports by piercing a needle of a syringe through the plug and the injection ports into the soft shell portion.

### BACKGROUND OF THE INVENTION

The present invention relates to an ornamental water ball, and more particularly to an ornamental water ball having two discs positioned at inner and outer sides of a lower edge of a soft shell portion forming the water ball, so that the lower edge of the water ball is firmly clamped between the two discs without the risk of leakage, and ornamental liquid may be injected into the water ball via injection ports provided on the two discs.

A water ball is a common ornament and typically includes a base and a shell portion that is filled with a certain type of liquid and floating decorations to form a water ball on the base. The shell portion may be formed from a soft or a hard material and is not necessarily limited to a ball shape. However, it is preferable the shell portion could be easily shaped and is not easily subject to breaking or other damages. To complete such ornamental water ball, it is very important to fill the liquid into such soft shell portion and assemble the same to the base in a watertight manner. Many differently designed ornamental water balls have been disclosed, including U.S. patent application Ser. No. 09/726,415 filed on Dec. 1, 2000 by the same applicant of the present application. In the U.S. patent application Ser. No. 09/726,415, an adjustable binding strap is used to tightly tie up a lower opening of a soft shell, so that the ornamental water ball is leakproof. However, it is desirable to develop other simpler and more effective way for forming a leakproof ornamental water ball.

### SUMMARY OF THE INVENTION

A primary object of the present invention is to provide an ornamental water ball that includes means to enable easy and leakproof assembling of the water ball.

Another object of the present invention is to provide an ornamental water ball that includes means to enable easy injection of liquid into the water ball without the risk of leakage.

To achieve the above and other objects, the ornamental water ball of the present invention includes a base and a soft shell portion located on a top of the base. The soft shell portion may be designed into different shapes. Two discs are separately positioned at inner and outer sides of a peripheral area surrounding a bottom opening of the soft shell portion and are locked into one unit with screws to tightly clamp the peripheral area of the soft shell portion between them. The two discs are provided at the sides facing each other with annular ribs and annular grooves that engage with one another to continuously bend the peripheral area of the soft shell portion while clamping the same between them. Inner and outer injection ports are provided at centers of the two discs and a plug is compressed between the two discs to seal the two injection ports. Ornamental liquid may be injected into the soft shell portion via the injection ports by piercing a needle of a syringe through the plug and the injection ports into the soft shell portion.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an ornamental water ball according to an embodiment of the present invention;

FIG. 2 is an exploded perspective view of the soft shell portion of the ornamental water ball of FIG. 1;

FIG. 3 is a fragmentary, sectioned side view of the ornamental water ball of FIG. 1 showing the manner of sealing a lower opening of the soft shell portion and the connection of the soft shell portion to a base below it;

FIG. 4 is a perspective view of an ornamental water ball according to another embodiment of the present invention;

FIG. 5 is another ornamental water ball of the present invention showing a differently shaped soft shell portion; and

FIG. 6 is still another ornamental water ball of the present invention showing a differently shaped soft shell portion.

### DETAILED DESCRIPTION OF THE PREFERRED EMBODIMENTS

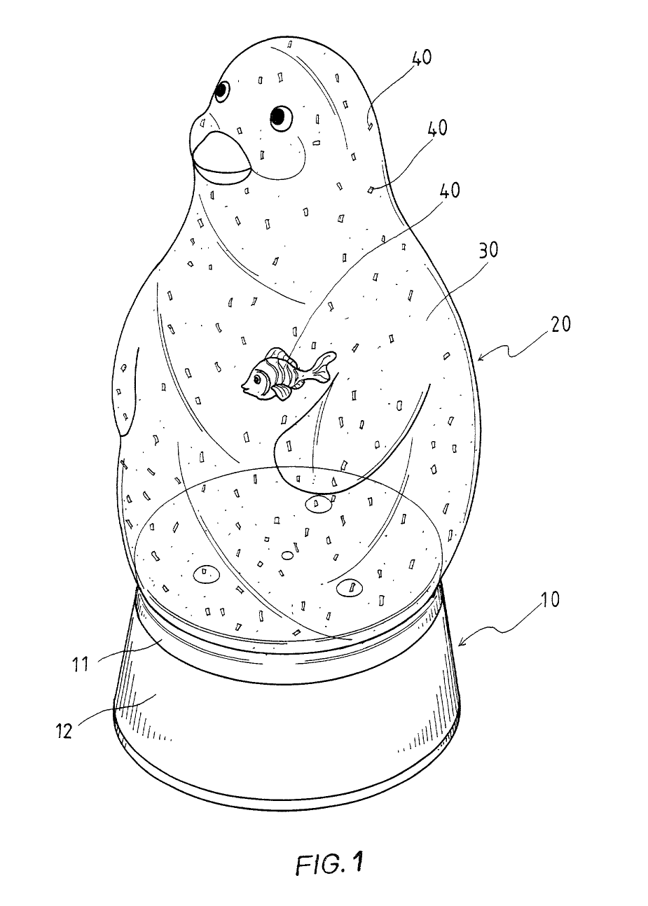

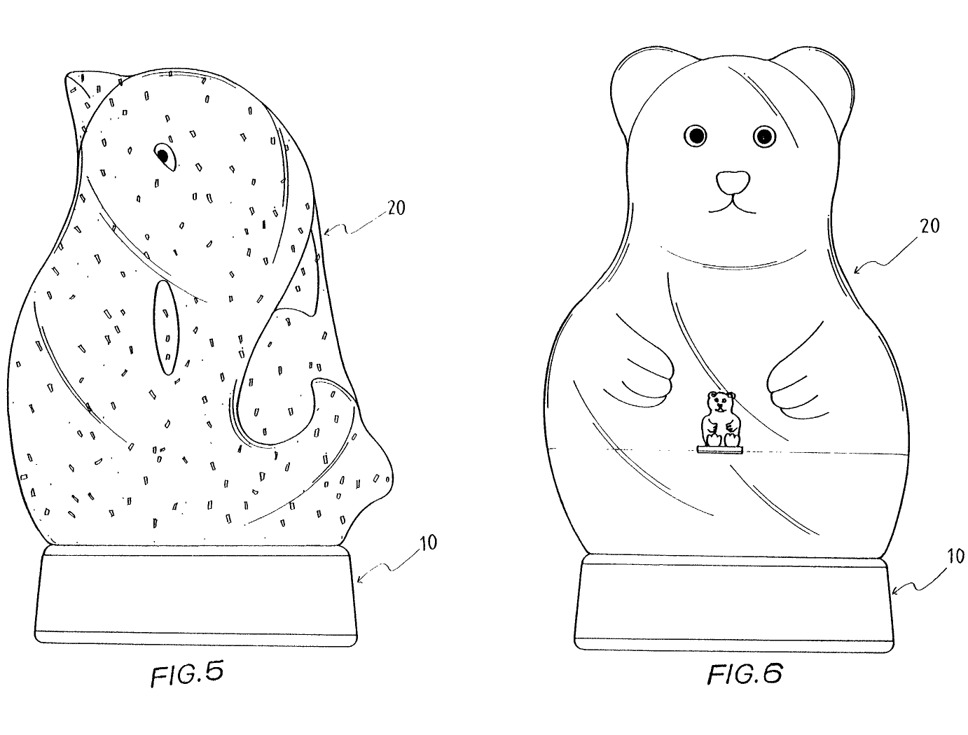

Please refer to FIG. 1. The present invention relates to an ornamental water ball including a base 10 and a soft shell portion 20 above the base 10. The soft shell portion 20 is not necessarily limited to a common spherical shape. It could be any other shape, such as a penguin shown in FIG. 1, a dolphin in FIG. 5 or a bear in FIG. 6. Since the soft shell portion 20 is made of a transparent plastic or elastomer material and is in the form of a thin layer, it is preferable that the water ball of the present invention is designed to show curved lines without acute angles. The soft shell portion 20 may be painted at suitable positions to show suitable colors and/or lines so as to highlight a special appearance of the ornamental water ball. The soft shell portion 20 may be filled with a mono-liquid 30 as shown in FIG. 1, or a dual-liquid as shown in FIG. 5. Various floating decorations 40 may be positioned in the soft shell portion 20 to float on the liquid 30.

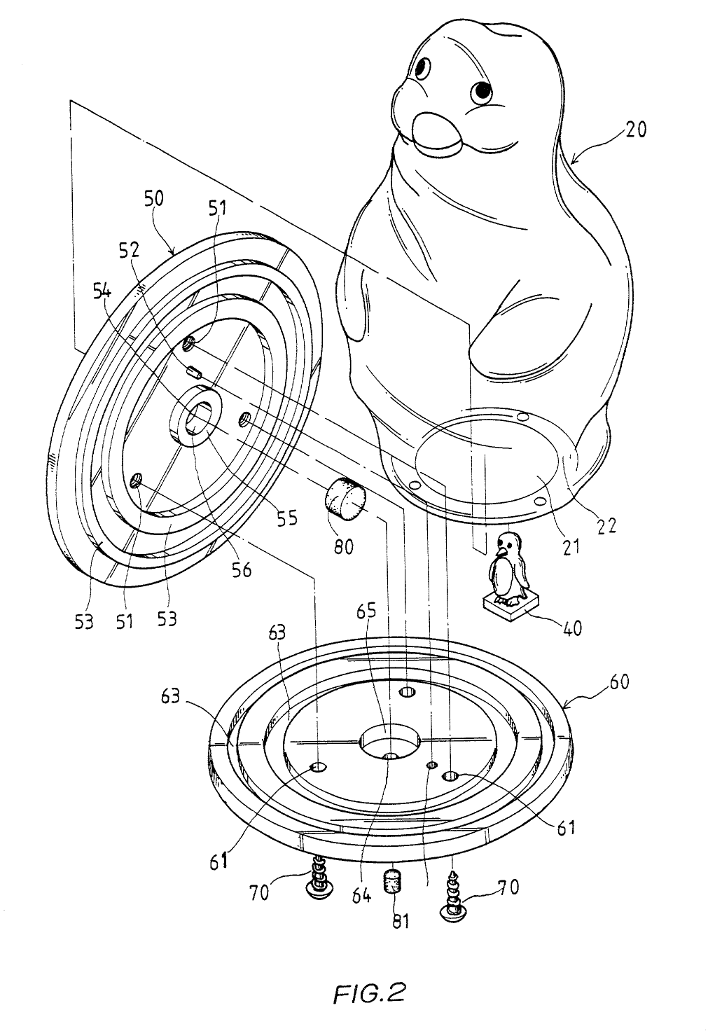

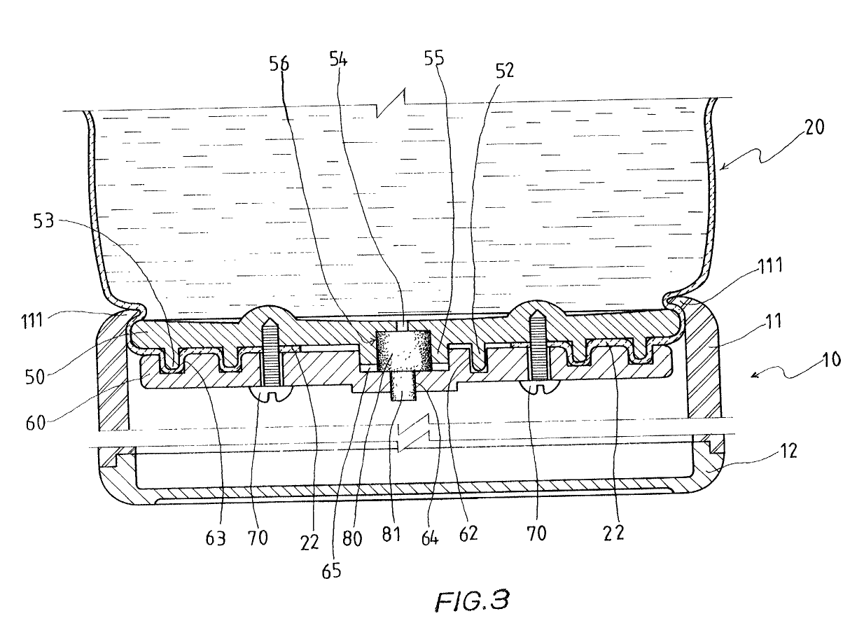

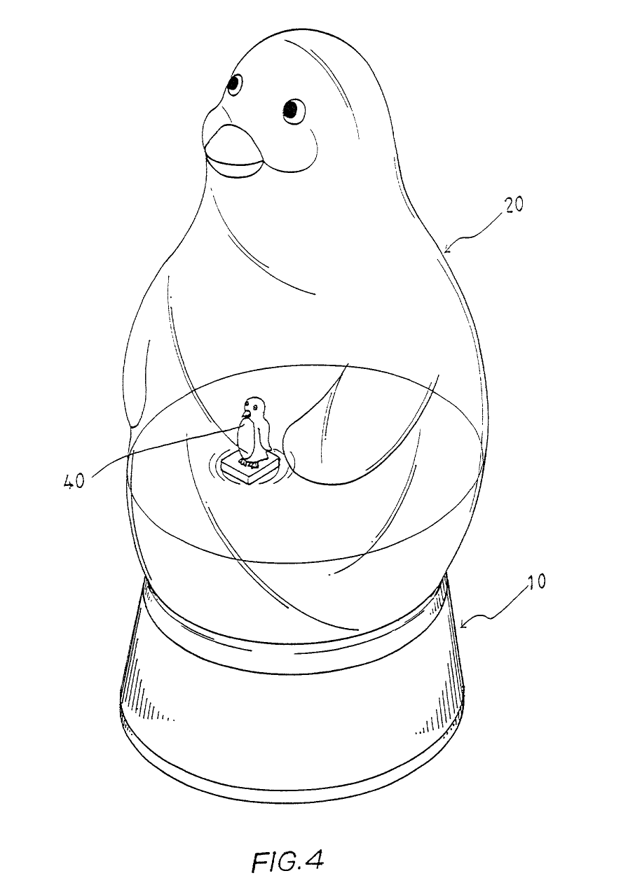

Please refer to FIGS. 2 and 3 at the same time. The ornamental water ball of the present invention is characterized in the manner of sealing a bottom opening 21 of the soft shell portion 20 by positioning two substantially complementary discs 50, 60 at an inner and an outer side, respectively, of the bottom opening 21 of the soft shell portion 20 to firmly clamp a peripheral area 22 of the bottom opening 21 between the two discs 50, 60. The two discs 50, 60 are locked into one unit with a plurality of circumferentially spaced screws 70. To do so, the screws 70 are upward extended from a lower side of the outer disc 60 through holes 61 provided thereat and then into internally threaded dead holes 51 provided at a lower side of the inner disc 50. To enable easy alignment of the threaded dead holes 51 with the holes 61, a downward projected locating pin 52 and a locating hole 62 are provided on the two discs 50, 60, respectively. Both the holes 51, 61 are provided within a central area of the discs 50, 60. An annular area of the inner disc 50 outside the central area having the holes 51 is provided with a plurality of concentric annular ribs 53, and an annular area of the outer disc 60 outside the central area having the holes 61 is provided with a plurality of concentric annular grooves 63 corresponding to the annular ribs 53, such that the peripheral area 22 of the soft shell portion 20 is continuously bent and tightly clamped between the annular ribs 53 and the annular grooves 63 when the two discs 50, 60 are locked into one unit with the screws 70. This type of arrangement of continuously bending the peripheral area 22 of the soft shell portion 20 prevents any leakage at joints of the peripheral area 22 and the two discs 50, 60.

The two discs 50, 60 are further provided at their centers with two corresponding injection ports 54, 64. A downward extended circular wall 55 is provided at the lower side of the inner disc 50 immediately below the injection port 54. The circular wall 55 defines an inner space 56 having a diameter larger than that of the injection port 54, so that a first plug 80 made of elastic and flexible material could be tightly inserted into the space 56 to fully seal the injection port 54. A round recess 65 is provided on an upper side of the disc 60 around the injection port 64 to fitly receive the circular wall 55 therein. However, the round recess 65 has a depth larger than a length of the circular wall 55, so that a lower end of the circular wall 55 is not in contact with a bottom of the round recess 65 and the first plug 80 is firmly compressed between the two injection ports 54, 65 when the two discs 50, 60 are fully locked together. That is, any leakage at the two injection ports 54, 64 is prevented. Liquid 30 is then injected into the soft shell portion 20 via the injection ports 54, 64 by piercing a needle of a syringe containing the liquid 30 through the first plug 80 into the soft shell portion 20. After the injection is done, a second plug 81 also made of elastic and flexible material is inserted into the injection port 64 to tightly press against the first plug 80 and seal any needle hole formed on the first plug 80 during injecting the liquid 30 into the soft shell portion 20, in order to ensure that the ornamental water ball of the present invention is absolutely leakproof.

The base 10 of the ornamental water ball of the present invention includes an upper ring portion 11, an inner edge 111 of which has an inner diameter slightly smaller than an outer diameter of the disc 50, and a lower seat portion 12 detachably connected to a lower end of the upper ring portion 11. When the soft shell portion 20 and the two discs 50, 60 are locked into one unit and the soft shell portion 20 is filled with the liquid 30 in the above-described manner, the soft shell portion 20 is upward extended through the ring portion 11 of the base 10 until the disc 50 is stopped by the inner edge 111 of the ring portion 11, and a part of the soft shell portion 20 is bent and firmly clamped between the disc 50 and the upper ring portion 11. Finally, the lower seat portion 12 of the base 10 is connected to the upper ring portion 1 to complete an ornamental water ball of the present invention.

What is claimed is:

1. An ornamental water ball, comprising a base and a soft shell portion located at a top of said base;
said base including an upper ring portion and a lower seat portion detachably connected to a lower end of the upper ring portion; and
said soft shell portion being made of a thin layer of a transparent elastomer material for containing a desired type of liquid and various floating decorations therein;
said ornamental water ball being characterized in that a peripheral area surrounding a bottom opening of said soft shell portion is clamped between an inner and an outer disc positioned inside and outside said peripheral area, respectively; said inner and said outer discs being locked into one unit with a plurality of circumferentially spaced screws that are upward extended from a lower side of said outer disc through holes provided thereat and then into internally threaded dead holes provided at a lower side of said inner disc; said inner disc being provided at an outer annular area of the lower side with a plurality of concentric annular ribs, and said outer disc being provided at an outer annular area of an upper side with a plurality of concentric annular grooves corresponding to said annular ribs, such that said peripheral area of said soft shell portion is continuously bent and tightly clamped between said annular ribs and said annular grooves when said inner and said outer discs 50 are locked into one unit with said screws; and
said inner and said outer discs being provided at their centers with an inner and an outer injection port, respectively, a downward extended circular wall being provided at the lower side of said inner disc immediately below said inner injection port to define an inner space having a predetermined diameter larger than that of said inner injection port for a first plug made of elastic and flexible material to tightly inserted thereinto, a round recess being provided on the upper side of said outer disc around said outer injection port to fitly receive said circular wall therein, and said round recess having a depth larger than a length of said circular wall, so that a lower end of said circular wall is not in contact with a bottom of said round recess to firmly compress said first plug between said inner and said outer injection ports when the inner and said outer discs are fully locked together, preventing any leakage at said inner injection port.

2. The ornamental water ball as claimed in claim 1, wherein said inner and said outer discs are correspondingly provided with a downward projected locating pin and a locating hole, respectively, to enable easy alignment of said inner with said outer disc for locking them into one unit.

3. The ornamental water ball as claimed in claim 1, wherein a second elastic and flexible plug is inserted in said outer injection port on said outer disc to prevent leakage at said outer injection port.

4. The ornamental water ball as claimed in claim 1, wherein said inner disc has an outer diameter slightly larger than an inner diameter of said upper ring portion of said base, so that said inner disc is stopped at an inner side of said upper ring portion of said base.
